(19) United States
(12) Patent Application Publication
(10) Pub. No.: US 2011/0243180 A1
(43) Pub. Date: Oct. 6, 2011

(54) METHOD AND DEVICE FOR THE CONTINUOUS MELTING OR REFINING OF MELTS

(75) Inventors: Uwe Kolberg, Mainz (DE); Sybill Nuettgens, Frankfurt (DE); Andreas Gross, Undenheim (DE)

(73) Assignee: Schott AG,

(21) Appl. No.: 12/834,240

(22) Filed: Jul. 12, 2010

(30) Foreign Application Priority Data
Jul. 15, 2009 (DE) 10 2009 033 501.3

(51) Int. Cl. F27D 3/00

(52) U.S. Cl. 373/142

(57) ABSTRACT

A method for the continuous production of products from a melt is provided. The method includes heating the melt to a predetermined temperature in a skull crucible, the bottom of which is formed from electrically non-conductive, but thermally conductive material.

### CROSS REFERENCE TO RELATED APPLICATIONS

This application claims benefit under 35 U.S.C. §119(a) of German Patent Application No. 10 2009 033 501.3, filed Jul. 15, 2009, the entire contents of which are incorporated herein by reference.

### BACKGROUND OF THE INVENTION

1. Field of the Invention

The invention relates to a method and a device for the continuous production, in particular, of glass and glass ceramic products from a glass melt.

2. Description of Related Art

Glass products, such as, in particular, high-purity glasses and glass ceramics, are generally produced in melt vessels from noble metals, such as platinum or platinum alloys, as well as from silica glass. However, these have known drawbacks, such as, for example, a yellowing due to ionic platinum entrained into the glass melts and/or scattering effects on entrained platinum particles as well as streaks and other inhomogeneities due to dissolution of the silica glass crucible material in the glass melt.

In addition, glass melts for high-purity glasses and glass ceramics are often quite aggressive toward the crucible materials used in each case. As a result, wear of the equipment and a premature end of the production occurs.

Known from DE 102 44 807 A1 is a remedy for these drawbacks through the use of a so-called skull melting unit, which comprises a multi-turn coil constructed from water-cooled copper pipes and a skull crucible constituted of pipes made of metal (Cu, Al, Ni—Cr—Fe alloy, or possibly Pt) and having a palisade-like arrangement parallel to the coil axis. The pipes of the skull crucible must have a minimum spacing in order to enable the applied high-frequency electric field to penetrate into the fluid glass present in the skull crucible and to heat it further by direct in-coupling with the creation of eddy currents. A crust of solidified/crystallized intrinsic material forms between the cooled metal crucible and the hot glass. This has the function of protecting the metallic crucible against corrosive glass attack and of protecting the glass against the entrainment of impurities from the metal and forms a leakage barrier and effects a reduction of heat losses from the glass to the cooling medium.

These functions are fulfilled by the cited melting method. Furthermore, it is possible to produce glass products having good quality. However, the melting method has the drawbacks presented below.

The necessary high operating voltages of greater than 1000 V result repeatedly in flashovers, mostly between the coil and the crucible, especially in dusty surroundings. This can result in long-lasting interruptions in operation and thus lead to high production costs.

The high voltages pose a potential source of danger for the persons operating the unit.

The construction of the crucible is time-consuming and cost-intensive due to the complex design.

Two cooling circuits are required, namely, one for the coil and one for the crucible. This results in additional costs.

As a result, idle powers of 10 to 20% of the total power are created, in particular due to the voltage drop at the crucible.

Known in the literature for the partially continuous melting of ceramic materials are units that operate with an inductor crucible: for example, DE 41 06 537 A1, DE 41 06 536 A1, DE 41 06 535 A1. These relate to methods for the partially continuous melting of ceramic materials by inductive heating in high-frequency and intermediate-frequency induction melting ovens, the melting coil of which surrounds a sinter crust crucible (skull crucible) and includes a leakage device. The unit is used in the documents, by way of example, for the melting of zirconium sand. The melting temperatures lie at approximately 2700° C.

Further presented is an invention that uses monoclinic zirconium oxide having an SiO₂ content of 1%. The melted material is transferred on tapping to a cooled channel system, which, in turn, is used to quench the charging material.

However, the melting devices described in the documents presented above cannot be used for the production of glass or glass ceramics, because these two classes of substance tend to form only relatively thin sinter crusts. Therefore, the sinter crust or also the so-called skull layer which form isolates the melt volume only to a very small extent from the water-cooled coil. Flashovers can result between the coil and the glass volume. Furthermore, there exists the drawback that the thin skull layer leads to the dissipation of a large amount of energy from the melt volume to the cooling water. Moreover, the viscosity of the glass melts changes constantly in contrast to that of ceramic materials, which exhibit a jump in the viscosity curve at the melting point. This often results in the crust not being rigid, but rather remaining soft and deformable. Partially formed is a mixture of crystallized and glassy regions. This crust in glasses is often, therefore, not all too durable mechanically.

In the case of small vessels, for which the fluid melt contents exert a small hydrostatic pressure, this might be adequate. In the case of large melting units exhibiting a high hydrostatic pressure, by contrast, this can result in a breakthrough with subsequent leakage of the charging material.

Moreover, energy is absorbed in the coil, which functions as inductor, and in the metallic bottom and is no longer available for the melting process. In order to enable at all a heating with the inductor crucible, an energy input that is as efficient as possible must be ensured. Losses in the metallic materials that belong to the melting unit must be minimized to the greatest degree possible. Opposed to the use of ceramics in the melting unit, however, is the high corrosiveness toward ceramic materials that many glass and glass ceramic melts display. If ceramics made of refractory components are used for the melting unit, therefore, there is no adequate leakage protection. In addition, the dissolution products of the ceramic linings result in streaks, bubbles, discolorations, and other flaws in the glass, which can substantially impair the quality of the product.

The dissertation “Process-Oriented Analysis of Inductive Skull Melting Technology Using a Transistor Inverter” by Torge Behrens deals with the discontinuous melting, in particular, of glass melts in an inductor crucible. The crucibles described therein, however, exhibit the drawback that their service lives are relatively short.

Accordingly posed is the problem of providing a method and a device for the direct heating of glass melts by means of electromagnetic fields, in which the melting operation or the refining operation takes place continuously.

### BRIEF SUMMARY OF THE INVENTION

The invention is aimed at avoiding the above-discussed drawbacks, such as lacking flashover resistance, high energy losses, and lacking leakage protection, while retaining the positive effects, such as high purity of the glass product and long service lives of the crucible.

The method according to the invention for the production of glass or glass ceramic products from a glass melt has the following method steps: feeding of the melt raw materials or a pre-melt into an inductor crucible, heating of the melt to a predetermined temperature in an inductor crucible by means of a high-frequency alternating field, wherein the wall of the inductor crucible comprises an electrically conductive inductor and a bottom made of an electrically non-conductive, but thermally conductive material, with the electrical conductivity of the bottom being less than 10⁻³ S/m, preferably less than 10⁻⁸ S/m at a temperature of 20° C., continuous discharge of the melt heated to the predetermined temperature, wherein the side wall and the bottom are cooled, so that a skull layer is formed in the interior of the crucible, and wherein the side wall of the inductor crucible comprises or forms the coil for application of the high-frequency field, and wherein, in long-term operation, the crucible has a service life of at least two months or be operated for at least two months in long-term operation. Appreciably longer service lives are also possible using the crucible according to the invention. Preferably, the operating time is at least half a year. A briefly interrupted operation, in this case, is also regarded as long-term operation, as long as the crucible is operated at least 85% of the operating time in melting operation.

The heating of the melt takes place preferably by means of electromagnetic fields in the frequency range of 70 kHz to 2 MHz. In this case, it was surprisingly found that, for glasses, an operation with frequencies of less than 100 kHz, even less than 90 kHz, is also possible. This is of advantage in regard to, among other things, the reduced electromagnetic radiation from the unit.

The inductor, or the crucible side wall, can be designed with, in particular, one turn in this case. This reduces markedly the danger of flashovers, because, here, higher potential differences occur only in the region of the inductor gap. In addition, in comparison to multi-turn crucibles, the operating voltage is reduced, which increases the operating safety.

The method is employed particularly preferably for the continuous production of glass products from a glass melt. The device and the method have also proven suitable for the continuous production and/or the continuous refinement of glasses for glass ceramics. In terms of the invention, a glass ceramic is understood to be, in this case, particularly a material having crystallites and a residual glass phase, with the residual glass phase having a proportion of at least 0.01, preferably 0.1 volume percent.

A corresponding device for the production of glass or glass ceramic products from a glass melt has at least the following features: means for feeding in melt raw materials or for feeding in a pre-melt, an inductor crucible for heating the melt to a predetermined temperature, wherein the wall of the inductor crucible preferably comprises a one-turn electrically conductive inductor and the bottom of the inductor crucible comprises an electrically non-conductive, but thermally conductive material, means for cooling the side wall and the bottom, means for continuously discharging the melt that has been heated to a predetermined temperature.

The device can be constructed as a melting and/or refining assembly.

Regarded as thermally conductive materials for the bottom in terms of the invention are, in general, those materials that have a thermal conductivity of at least 20 W/m·K.

In accordance with an embodiment of the invention, the thermal conductivity of the bottom material is preferably greater than 85 W/m·K, in particular greater than 150 W/m·K.

The electrical conductivity of the bottom material is preferably less than 10⁻³ S/m, particularly preferably less than 10⁻⁸ S/m, at 20° C.

Nitride-containing materials, preferably nitride ceramics, have proven to be advantageous as suitable bottom material, in particular also ceramics made from aluminum nitride. Further suitable substances are, among others, titanium nitride, boron nitride, and silicon nitride. Although titanium nitride has a good thermal conductivity, it is metallic in pure form. In order to prevent high current conductance, this material can be used, for example, in mixture or as a mixed compound with another material. In general, the aforementioned materials for the bottom element can be present with one another or with other materials in mixture or mixed compound. It is also conceivable to employ these materials as coatings in the region of the crucible bottom or of the crucible side wall.

Nitride ceramics have, in general, the advantage that they have relatively high thermal conductivities and, moreover, also have a relatively low surface energy. The latter leads to the fact that the melt engages in chemical bonding to the bottom material either not at all or only to a small extent. This has the advantage that the skull material or the crust that forms can be removed in a very simple manner. If the crucible bottom is designed to be removed, for example, the skull material can simply be taken out from below. In this case, the actual bottom material is not eroded by mechanical or chemical treatment, as is conventionally the case. This material advantage is especially important when the crucible is to be used for the melting of various materials, for example, of various high-purity glasses of differing composition. The “cleaning” of the crucible and the melting of a new composition can then take place within a very short time.

Particularly advantageous in terms of high thermal conductivity and low electrical thermal conductivity is aluminum nitride ceramic, which, as an insulator material, has an exceptionally high thermal conductivity with high temperature stability and high electrical insulating capacity. This material can be combined, if necessary, with other materials in order to improve the properties further. Possible, for example, is a coating or admixture of other materials in order, for instance, to improve the chemical resistance.

A further clear improvement results from the use of a boron nitride-containing aluminum nitride ceramic. Although such a material has a lower thermal conductivity in comparison to a pure aluminum nitride ceramic, appreciable advantages are obtained. In general, these advantages can be obtained when the thermal conductivity is still at least 85 W/m·K. Thus, this mixed ceramic proves to be appreciably easier to process. Yet another advantage is the lower dielectric constant. For pure aluminum nitride, generally a value of the dielectric constant at 1 MHz of about 9 is given. For a boron nitride-containing aluminum nitride ceramic having the above-given minimum thermal conductivity, this value can be lowered to less than 8.0. In general, materials having such dielectric constants prove to be advantageous in order to minimize dielectric losses in the bottom part.

Advantageously, nitride ceramics having low oxygen contents are used, because the thermal conductivity of aluminum nitride depends greatly on the oxygen content. With increasing oxygen content, the thermal conductivity decreases asymptotically. For this reason, aluminum nitride ceramic having an oxygen content of less than 2 mol % is preferably used as the bottom material.

Aluminum nitride is, moreover, relatively easily oxidized, with the oxidation rate increasing linearly with the temperature. An adequate cooling of the bottom material is important, therefore, in order to prevent oxidation of the bottom material, on the one hand, by atmospheric oxygen and, on the other hand, above all by oxygen from the melt. Once this process commences, it leads to a self-reinforcing process: an increased temperature leads to enhanced oxidation and enhanced oxidation lowers the thermal conductivity of the material and thus leads, in turn, to increased temperatures. In a particularly preferred enhancement of the invention, the bottom is cooled in such a way that its surface temperature on the side facing the melt, or on its interior side is less than 750° C., preferably less than 500° C.

The preferred low oxygen content in accordance with the invention and thus the prevention of the above-described self-reinforcing process increase the service life of the crucible.

If the dimensions of the crucible exceed a certain size, there arises the problem that it is difficult to fabricate nitride ceramic elements of sufficient size for the crucible bottom or else they are not at all available commercially.

Therefore, for the case of a large crucible, it is preferably provided that the bottom of the crucible comprises several components, preferably made of a nitride ceramic. The crucible bottom is thus composed of at least two components by means of tiling. In this case, the individual components can have, for example, mutually engaging elements, by means of which it is possible to join them together. These elements can be, for example, tongues and grooves, which serve for connection of the components, on the one hand, and for preventing the components from being displaced with respect to one another, on the other hand.

The side wall of the crucible can also be coated. Among others, an aluminum oxide coating can further improve the properties of the crucible in this case. Aluminum oxide is also highly electrically insulating. This or another insulating coating can be applied to the inductor, for example, in the regions of the inductor gap and prevent short circuits there. A further possibility is also a plastic coating in order to improve the electrical insulation toward the melt. Particularly suitable in this case is Teflon. In general, it is advantageous in this case when the metal on which the coating is applied has a thermal conductivity of at least 50 W/m·K. Coming into consideration for this purpose are, in particular, copper, aluminum, silver, possibly even brass. Materials such as Inconel, a nickel-based steel alloy, have too poor a thermal conductivity. It has been found here that the energy dissipation into the cooling water is too small and the Teflon layer detaches after several hundred hours in the course of operation. If a Teflon coating is used, it is further advantageous either to weld the joints present on the crucible or to produce them with hard solder. A soft solder joint is, in any case, a drawback. Because the temperature exposure is about 400° C. when the Teflon layer is applied, conventional soft solders melt and drip off.

The device according to the invention shows an exceptionally high efficiency for a skull crucible. It could be verified that an efficiency can be achieved in which at least 40% of the electrical input power is introduced into the melt as heat input.

In operation, temperatures of greater than 2500° C. and even markedly greater than 3000° C. could be attained. This allows, among other things, a rapid refining of glasses and/or glass ceramics, which is advantageous for a continuous production and/or refinement process or even enables such process at all. The method thus allows also the production of glasses and glass ceramics that hitherto could not be produced or else could be produced only with difficulty. Conceivable, among other things, are ultrahigh-melting glasses.

Because, in regard to the method according to the invention by means of the device, a very energy-efficient, rapid heating is achieved, new process designs are possible. Thus, steeper temperature profiles, a better refinement, and other oxidation states of the components of glasses or ceramics can be achieved.

The device according to the invention is designed for a continuous operation. Continuous operation is understood to mean a mode of operation in which melted material is continuously discharged. The introduction of the charging material can also take place continuously or in batches.

In this case, the discharging of the melt during a continuous operation can take place continuously through a ceramic or noble metal pipe or else through a channel made of these materials, which is attached to the bottom of the crucible. Alternatively or additionally, the melt can also be discharged continuously through the electrically conducting wall of the inductor crucible. An introduction of the melt through the electrically conducting wall of the inductor crucible also offers itself as a possibility when the device according to the invention is employed as an assembly for the continuous refinement of glasses and/or glass ceramics.

Between the actual infeed line and outflow line of the melt, in this case, it is possible to provide an insulating element or a connecting element, which, on the one hand, electrically insulates the inductor wall from the actual infeed or outflow line and which, on the other hand, is not sensitive to the corrosive attack of the melt. In general, therefore, regardless of the design of the skull crucible, in particular also regardless of whether a bottom made of nitride ceramic is provided, the invention relates to a device for the infeed or outflow of melt into or out of the crucible, wherein a connecting element made of a material having good thermal conductivity and poor electric conductivity, that is, for example, one made of a nitride ceramic, is passed through the bottom or the wall of the crucible.

Regardless of the arrangement of the outflow and/or, in the case of a refining assembly, of the inflow for the melt, it is particularly preferred when the outflow or the inflow is constructed at least in a first segment opening into the crucible, as a ceramic element having a high thermal conductivity and a low electric conductivity. Low electric conductivity is understood to mean a value of less than 10⁻³ S/m, preferably less than 10⁻⁸ S/m; good thermal conductivity is understood to be a value of greater than 20 W/m·K, preferably greater than 85 W/m·K, and particularly preferably greater than 150 W/m·K. Particularly preferably, such a component can be made of an aluminum nitride-containing ceramic. In this way, a very high temperature stability with as little influence as possible by the high-frequency current that flows through the inductor crucible is made possible.

A preferred enhancement of the invention provides that the connecting element is cooled. This can occur by means of its own cooling circuit; however, the connecting element also can advantageously be joined to the cooling circuit of the crucible.

According to another variant of the invention, the cooling of the connecting element, which indeed has a high thermal conductivity according to the invention, is sufficient to cool a noble metal pipe or a noble metal channel that projects through the connecting element into the melt. Advantageously, then, this pipe or this channel need no longer be cooled separately in this region.

A likewise melt-feeding noble metal element can then adjoin this insulating element or connecting element. The two elements can be employed jointly in a particularly advantageous manner as inflow or outflow, particularly also as a conditioning segment. In the ceramic element, in this case, the melt is preferably cooled down to a temperature that permits the passage of the melt in the noble metal element. The two elements can be designed independently of each other as channels or pipes. This conditioning segment permits, in a very simple manner, the skull crucible having very high melt temperatures to be connected to other devices for glass product production, such as, for example, facilities for glass shaping. For example, a roller device could be adjoined to the conditioning segment. In order to condition the melt, at least one heating as well as at least one cooling device can be provided. Due to the high thermal conductivity and electrical insulation of the ceramic, this permits both a heating, also an inductive heating, as well as a cooling of the melt.

It is clear that such an inflow or outflow, in particular in the form of a conditioning segment, can also be employed in conjunction with melting or refining assemblies that differ from the inductor crucible according to the invention. For example, these conditioning segments can also be joined to conventional skull crucibles with separate coil.

Therefore, within the scope of the invention, even in general, there is an inflow and an outflow or, in particular, a conditioning segment for the conditioning of glass and/or glass ceramics melts, which has a first melt-feeding element and a second melt-feeding element adjoined thereto, wherein the first melt-feeding element is a ceramic pipe or a ceramic channel, the ceramic of which contains aluminum nitride, and wherein the second melt-feeding element is a noble metal pipe or a noble metal channel. Heating and cooling elements can be provided for the two elements. For example, the melt can be cooled overall when passing through the conditioning segment, but also a heating can subsequently take place at the noble metal element, in order to reduce the temperature gradients in the cross section toward the center of the melt and thus to obtain a more homogeneous temperature distribution. If a skull crucible, such as, in particular, also the inductor crucible according to the invention is used, the conditioning segment is preferably constructed such that the ceramic element is attached to the skull crucible and the noble metal element adjoins it. This conditioning segment can also be employed for the feeding of melt in, for instance, a continuous refining assembly. Here, too, it is offered to connect the ceramic element to the crucible. In this case, the melt first traverses the noble metal element and subsequently the ceramic element.

Quite particularly suitable for the ceramic element is also a boron nitride-containing aluminum nitride ceramic. Suitable for the noble metal element are the usual metals used in the field of glass melting technology, such as platinum and platinum alloys or iridium and iridium alloys.

Because, as already mentioned at the beginning, the device according to the invention and the method that can be carried out therewith are also suitable for those materials that form only a thin skull layer, there results a particularly advantageous application also for so-called short glasses. Short glasses are those glasses that have a steep viscosity curve. In particular, in this case, the method is suitable for melting and/or refining those “short” glasses for which a temperature interval of at most 500° C. lies between the viscosity values 10^{7.6} dPa·s and 10³ dPa·s. A steep viscosity curve is often observed for borate glasses having a high borate content. In this case, a particular advantage of the melting and/or refining method according to the invention is obtained. First of all, the glasses are chemically very aggressive. On account of the non-conducting bottom in conjunction with the principle of the inductor crucible, a very homogeneous field distribution is attained. Particularly in the case of short glasses, as also for non-glassy materials that melt at a defined temperature, the homogeneity of the field leads to a correspondingly more homogeneous temperature distribution and thus to the formation of a more uniform skull layer. Accordingly, a contact of the melt with the bottom and/or the side wall is effectively prevented in spite of only a thin skull layer. Inhomogeneities of the skull layer thickness can otherwise lead to faster corrosion or even to a breakthrough of the melt. This applies all the more in the case of materials containing high contents of boric acid, which have a high chemical aggressiveness.

In addition, boric acid-containing glasses often have high Abbé numbers and therefore afford good optical glasses. Especially for such glasses, however, a high purity is desirable. This, too, is ensured by the especially uniform skull layer in the device according to the invention, because a contact with the side wall materials can be prevented.

Not all borate-containing glasses, however, are suitable for direct inductive heating, because some glasses do not couple sufficiently to the field. This applies, in particular, in the case when the glasses have only a small alkali content. The latter is desirable, because alkali oxides further lower the existing tendency toward poorer chemical stability of glasses having high contents of boric acid. On the other hand, alkali oxides increase the conductivity of the melt appreciably, which improves the coupling to the electromagnetic field during inductive heating.

However, borate-containing glasses that have as constituent at least one metal oxide, the metal ions of which are divalent or higher, with a molar proportion of at least 25 mol % and with the ratio of the molar proportion of silicon dioxide to borate in the charging material being less than or equal to 0.5, have also proven suitable. In this case, the molar proportion of alkali-containing compounds in the charging material is less than 2%, preferably less than 0.5%. These glasses thus couple to the alternating field regardless of the alkali content.

Suitable here are, in particular, borate-containing, low-alkali materials, such as, in particular, borosilicate glasses or borate glasses containing high contents of boric acid that have the following composition:

| | |
|---|---|
| B₂O₃ | is present at 15 to 75 mol %, |
| SiO₂ | at 0 to 40 mol %, |
| Al₂O₃, Ga₂O₃, In₂O₃ | at 0 to 25 mol %, |
| ΣM(II)O, M₂(III)O₃ | at 15 to 85 mol %, |
| ΣM(IV)O₂, M₂(V)O₅, M(VI)O₃ | 0 to 20 mol %, and |
| ΣM(I)₂O | at less than 0.50 mol %, and |
| wherein | |
| X(B₂O₃) | is >0.50, |

with
X(B₂O₃) = B₂O₃/(B₂O₃ + SiO₂),
M(I) = Li, Na, K, Rb, Cs,
M(II) = Mg, Ca, Sr, Ba, Zn, Cd, Pb, Cu,
M(III) = Sc, Y, ⁵⁷La, ⁷¹Lu, Bi,
M(IV) = Ti, Zr, Hf,
M(V) = Nb, Ta, and
M(VI) = Mo, W.

Here, the sum sign “Σ” designates the sum of all molar proportions listed following the sum sign. The percentages given are molar proportions in mol %. X(B₂O₃)=B₂O₃/(B₂O₃+SiO₂) still designates the mole fraction of the molar proportions of the network formers B₂O₃ to SiO₂.

Within this range of composition, particularly for the production of glasslike materials, such as borosilicate glasses or borate glasses containing high contents of boric acid, the composition of the melt is advantageously chosen such that the molar proportion of B₂O₃ is 15 to 75 mol % and the mole fraction X(B₂O₃) is >0.52. Particularly preferably, for the composition of the charging material, the proportion of B₂O₃ is chosen in the range between 20 and 70 mol %, the proportion of ΣM(II)O, M₂(III)O₃, that is, the sum of the molar proportions of oxides having divalent and trivalent metal ions, is chosen in the range between 15 and 80 mol %, and X(B₂O₃) is chosen to be >0.55.

Within the above-cited ranges of compositions of the boron-containing charging material, furthermore, a composition range is particularly advantageous for the optical properties of the glasses when, in the charging material, the proportion of

| | |
|---|---|
| B₂O₃ | is 28 to 70 mol %, the proportion of |
| B₂O₃ + SiO₂ | is 50 to 73 mol %, the proportion of |
| Al₂O₃, Ga₂O₃, In₂O₃ | is 0 to 10 mol %, and the proportion of |
| ΣM(II)O, M₂(III)O₃ | is 27 to 50 mol %, and |
| X(B₂O₃) | is >0.55. |

Particularly preferred in this case for the production of borosilicate glasses and borate glasses having a high content of boric acid, a composition of charging material is selected in which:

| | |
|---|---|
| B₂O₃ | is present at 36 to 66 mol %, |
| SiO₂ | at 0-40 mol %, |
| B₂O₃ + SiO₂ | at 55-68 mol %, |
| Al₂O₃, Ga₂O₃, In₂O₃ | at 0-2 mol %, |
| ΣM(II)O, M₂(III)O₃ | at 27 to 40 mol %, |
| ΣM(IV)O₂, M₂(V)O₅, M(VI)O₃ | at 0 to 15 mol %, and |
| X(B₂O₃) | is >0.65. |

According to another embodiment of the invention, which is particularly suitable for the preparation of borosilicate glasses and borate glasses containing high contents of boric acid for optical applications, the composition of the charging material is chosen such that the molar proportion of:

| | |
|---|---|
| B₂O₃ | is 45 to 66 mol %, of |
| SiO₂ | 0 to 12 mol %, of |
| B₂O₃ + SiO₂ | 55 to 68 mol %, of |
| Al₂O₃, Ga₂O₃, In₂O₃ | 0 to 0.5 mol %, of |
| ΣM(II)O | 0 to 40 mol %, of |
| ΣM₂(III)O₃ | 0 to 27 mol %, of |
| ΣM(II)O, M₂(III)O₃ | 27 to 40 mol %, and of |
| ΣM(IV)O₂, M₂(V)O₅, M(VI)O₃ | 0 to 15 mol %. |

In this case, the molar proportions of B₂O₃ and SiO₂ are additionally chosen such that X(B₂O₃) is >0.78.

In this variant of the method, particularly Mg, Ca, Sr, Ba, Zn, Cd, Pb are added as divalent metal ions, M(II). The transmission of the optical glasses thus obtained can be further improved when the charging material does not have any strongly coloring CuO. The network formers PbO and CdO are known in regard to their toxic effect. Therefore, it is advantageous to dispense with these components in the composition of the melt and to choose PbO-free and CdO-free compositions.

If a composition of the charging material is chosen in which:

| | |
|---|---|
| B₂O₃ | is present at 30 to 75 mol %, |
| SiO₂ | at < 1 mol %, |
| Al₂O₃, Ga₂O₃, In₂O₃ | at 0 to 25 mol %, |
| ΣM(II)O, M₂(III)O₃ | at 20 to 85 mol %, and |
| ΣM(IV)O₂, M₂(V)O₅, M(VI)O₃ | at 0 to 20 mol % |

and for which the ratio of the molar proportions of borate and silicon oxide is chosen such that X(B₂O₃) is >0.90, then, for example, besides borate glasses, also crystallizing boron-containing working materials, such as, in particular, glass ceramics, can be produced by means of this embodiment of the method according to the invention.

According to another embodiment of the method, which is particularly suitable for the production of crystallizing boron-containing materials, such as, for instance, glass ceramics, a composition of the charging material is chosen such that, in it, the molar proportion of

| | |
|---|---|
| B₂O₃ | is 20 to 50 mol %, of |
| SiO₂ | 0 to 40 mol %, of |
| Al₂O₃, Ga₂O₃, In₂O₃ | 0 to 25 mol %, of |
| ΣM(II)O, M₂(III)O₃ | 15 to 80 mol %, and of |
| ΣM(IV)O₂, M₂(V)O₅, M(VI)O₃ | 0 to 20 mol %, and |
| wherein X(B₂O₃) | is >0.52. |

Advantageously, in this embodiment of the method according to the invention, in order to achieve a good in-coupling, the composition of the charging material can be chosen such that X(B₂O₃) is >0.55.

The in-coupling of such melts can be further improved in this case when the molar proportion of

| | |
|---|---|
| ΣM(II)O | is 15 to 80 mol % and |
| M₂(III)O₃ | 0 to 5 mol % in the charging material, and |
| X(B₂O₃) | is >0.60. |

According to yet another advantageous variant of this method, the molar proportion of substances taken from a group comprising Al₂O₃, Ga₂O₃, and In₂O₃ is chosen, moreover, such that it does not exceed 5 mol %.

Particularly preferred is a variant of this embodiment of the method according to the invention in which the molar proportion of substances taken from a group comprising Al₂O₃, Ga₂O₃, and In₂O₃ does not exceed 3 mol % and in which the molar proportion of ΣM(II)O in the melt lies in the range of 15 to 80 mol %, with M(II) being chosen from a group comprising Zn, Pb, and Cu. In this case, the composition of the melt is chosen such that X(B₂O₃) is >0.65.

According to another embodiment, a composition is chosen for the charging material in which the molar proportion of:

| | |
|---|---|
| B₂O₃ | is 20 to 50 mol %, of |
| SiO₂ | 0 to 40 mol %, of |
| Al₂O₃ | 0 to 3 mol %, of |
| ΣZnO, PbO, CuO | 15 to 80 mol %, of |
| Bi₂O₃ | 0 to 1 mol % and of |
| ΣM(IV)O₂, M₂(V)O₅, M(VI)O₃ | 0 to 0.05 mol %. |

In this embodiment, the composition is chosen, moreover, such that X(B₂O₃) is >0.65.

According to a preferred variant of this embodiment of the method, the following molar proportions are chosen:

| | |
|---|---|
| B₂O₃ | 20 to 50 mol %, |
| SiO₂ | 0 to 40 mol %, |
| Al₂O₃ | 0 to 3 mol %, |
| ΣZnO, PbO, CuO | 15 to 80 mol %, |
| Bi₂O₃ | 0 to 1 mol %, and |
| ΣM(IV)O₂, M₂(V)O₅, M(VI)O₃ | 0 to 0.05 mol %. |

In this case, the molar proportions of borate and silicon oxide are advantageously chosen such that X(B₂O₃) is >0.65.

Obtained especially for high values of X(B₂O₃), in particular at X(B₂O₃) >0.60, are the properties of a steep viscosity curve, on the one hand, and a high Abbé number, on the other hand, so that, especially for these materials, special advantages in terms of purity and homogeneity result when the device according to the invention is used.

In the design of the device according to the invention as a melting assembly for glasses, there ensues a special advantage in terms of technical production when the interior of the crucible has a large width in relation to the depth. This makes possible an especially fast melting. Previous skull crucibles were, by contrast, relatively deeply constructed. The reason for this lay in the fact that very much heat was dissipated via the bottom. The use of an electrically non-conducting bottom and of the inductor crucible allowed the heat losses through the bottom to be markedly reduced. Therefore, for melting assemblies, it is possible to provide crucibles for which the inside width is at least one and a half times, preferably at least twice, the depth. Preferably, the coil and the crucible are combined into one unit, the so-called inductor crucible, and this is furnished with a bottom made of a thermally conductive, but electrically insulating ceramic, such as aluminum nitride (AlN).

The invention will be described in more detail below with reference to the attached drawings on the basis of preferred embodiments.

### BRIEF DESCRIPTION OF THE SEVERAL VIEWS OF THE DRAWINGS

FIG. 1, a first part of the bottom of the inductor crucible, an upper bottom plate, in which cooling water channels are milled, in a view as seen from below,

FIG. 2, the upper bottom plate illustrated in FIG. 1 of the bottom of the inductor crucible, in which the cooling water channels are milled, in a partial cross-sectional illustration as seen from the side,

FIG. 3, a second part of the bottom of the inductor crucible, a lower bottom plate, in which openings for the passage of cooling water are milled, in a view as seen from above,

FIG. 4, the lower bottom plate of the bottom of the inductor crucible illustrated in FIG. 3 in a partial cross-sectional illustration, as seen from the side,

FIG. 5, a view of an exemplary embodiment of the inductor crucible,

FIG. 6, a cross section through an inductor crucible constructed as a melting assembly,

FIG. 7, an inductor crucible constructed as a refining assembly,

FIG. 8, an inductor crucible with an adjoining conditioning segment, and

FIG. 9, mutually engaging bottom elements of the inductor crucible.

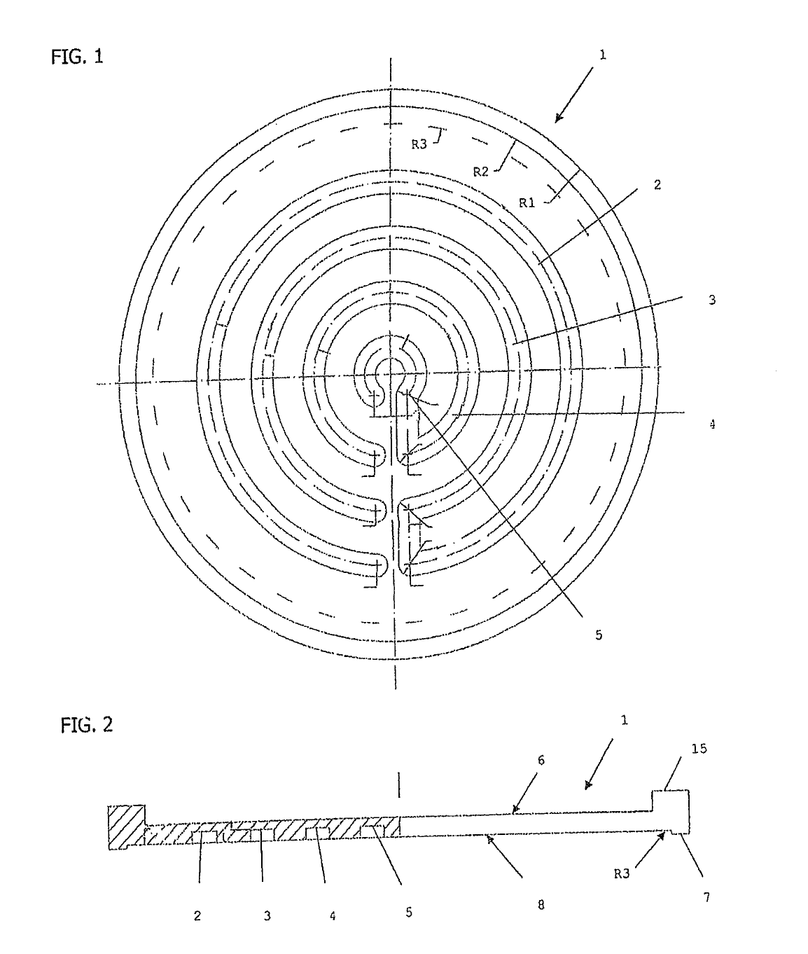

### DETAILED DESCRIPTION OF THE INVENTION

Devices for the discontinuous production of glass products from a glass melt, which are also referred to as skull crucibles, may be taken, for example, from the German Patent Application DE 10 2006 004 637.4 with the title “Inductively Heatable Skull Crucible,” the contents of which are assumed to be known in the following description. Consequently, because it is known to the skilled practitioner in this field and also for reasons of clarity, an unnecessary description of additional device and method parts that are already known from this publication will be dispensed with below.

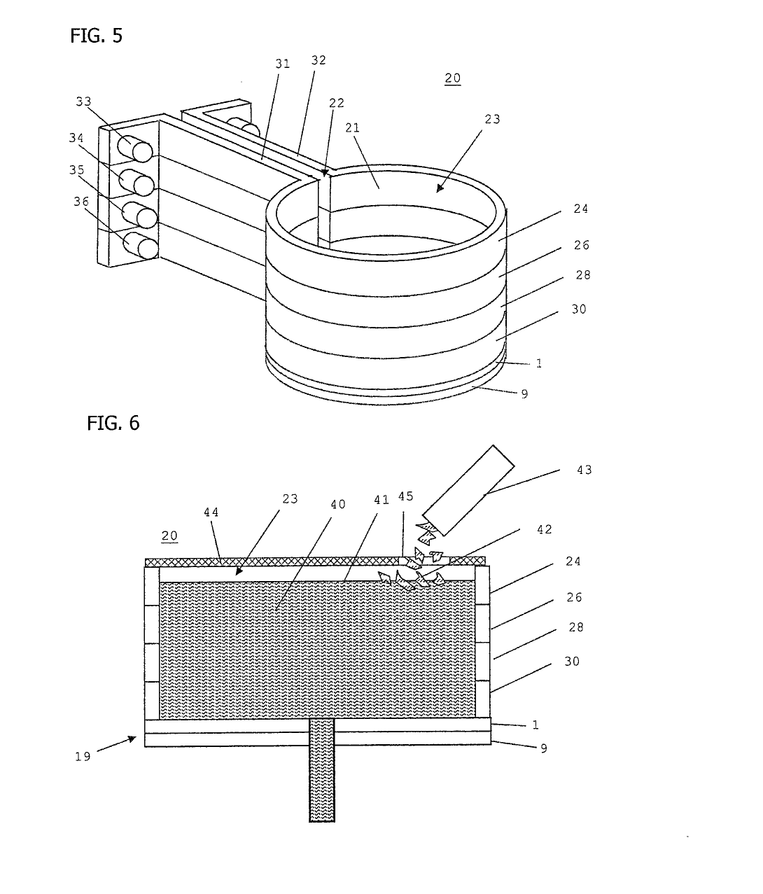

The inductor crucible 20 (FIG. 5) is conventionally fabricated from copper or from aluminum.

However, it can also consist of other materials, such as, for example, a Ni-based alloy, and may optionally be coated with Teflon or another material.

The inductor crucible is furnished with a protective layer 21, as described in more detail below, on the side (interior side) facing the charging material.

Furthermore, the connections of the inductor, which, because of the dual function of the inductor as the crucible and as the coil, must be tightly coupled to each other, are additionally electrically insulated in order to prevent flashovers.

Various materials may be used for the insulation, including a ceramic paste, a plasma-sprayed layer made of Al₂O₃, or Teflon.

Placed in the top edge of the inductor crucible is a Quarzal ring, which is not illustrated in FIG. 5, in order to ensure an air volume over the glass, which serves as head oven.

In order to heat this head oven and to supply the glass with the required energy for the starting process, the apparatus is further equipped with a burner. This burner is heated by means of a fossil energy carrier and makes possible the preheating of the glass to the fluid melt state with adequate electric conductivity, so that the high-frequency energy can be in-coupled.

The burner is oftentimes operated using a mixture of gas and oxygen. For this purpose, various gases or even oil may be used. Instead of oxygen, air may also be used.

The inductor crucible 20 serves as a one-turn coil, in which, by application of a high-frequency alternating voltage, a high-frequency field is generated. When the conductivity of the charging material is adequate, energy is absorbed in the melt.

This takes place through the induction of a current in the charging material, which is heated through the ohmic losses.

Due to the one-turn inductor, it is possible for the method to use an appreciably lower voltage up to 750 V, preferably of approximately 400 to 600 V, in relation to the high-frequency melting with a cold crucible.

The use of these low voltages enables a semiconductor generator to be used for the generation of the high-frequency field for the heating of the charging material. The advantage over high-frequency tube generators consists here in the fact that only a smaller part of the energy for generation of the required voltages in the generator is lost. When high frequencies are used, the device according to the invention can, however, be equipped alternatively or additionally also with a tube generator, in which the high-frequency currents are enhanced by electric tubes.

Another advantage of the lower voltage in comparison to high-frequency melting lies in the fact that the tendency toward flashovers is reduced. Flashovers occur in the case when the breakdown field strength of the surrounding medium is exceeded.

The lower the applied voltage, the lesser is the tendency toward flashovers. This leads to the fact that the situation in terms of work safety for the workers operating the unit is markedly improved.

Furthermore, dusts or vapors often arise in the production surroundings and lower the breakdown field strength of the air. Therefore, under harsh production conditions, this results often in equipment failures due to flashovers at conventional high-frequency-heated units with skull crucibles and operating voltages of several thousand volts. This leads to production stoppages and thus to high costs. With the markedly lower operating voltages of inductor crucible units, the likelihood of flashovers is greatly reduced and the cost situation improves.

Moreover, when the coil and skull are combined into a single component, the inductor crucible 20, the otherwise existing second cooling circuit for cooling of the coil is obviated. The construction is hereby simplified and costs are saved for the installation of the infrastructure and for the operation of the cooling circuit. In addition, the losses that would arise in a separated system in the crucible are prevented. The field of the inductor induces currents in the crucible, the powers of which are carried out of the unit by the cooling and make no contribution to heating of the glass. This is not the case for the combination of crucible and inductor.

In a special embodiment of the unit, the inductor crucible has a diameter R1 of 250 mm and a height of 160 mm. The capacity is approximately 8 liters and, in this case, comprises a net working volume of about 6 liters. In general, for continuous melting processes, larger crucibles having a capacity of at least 15 liters are preferred. Especially suitable, and particularly preferred for continuous melting or refining processes, however, are melting and/or refining devices having a crucible with a capacity of greater than 50 liters.

The height to diameter aspect ratio lies at 0.64. On its inner side, the inductor crucible has an insulation layer 21 made of Al₂O₃, which is applied by means of thermal methods.

This layer, having a thickness of approximately 500 μm, raises the electrical breakdown strength to several kilovolts. Without this coating, flashovers have occurred in the past when the skull layer became very thin as a result of overheating of the glass.

An insulation layer 21 is provided in this case, in particular in the region of the inductor gap 22, because, here, in the case of the one-turn design, the greatest potential differences occur.

The operating frequency of the unit lies in the range of approximately 70 to 400 kHz, preferably up to 300 kHz, and may be adjusted at will in this range by means of the capacitance of a capacitor bank. The capacitor bank is a component of an oscillatory circuit of the semiconductor generator, with the oscillation frequency of the oscillatory circuit being determined by the capacitance. In order to change the frequency, the capacitor bank may connect capacitors or it may disconnect capacitors from the bank. With other generators, even higher frequencies of up to about 2 MHz, preferably up to 1.4 MHz, may be adjusted.

Preferably, in this case, the oscillatory circuit is designed as a parallel oscillatory circuit, the capacitor bank forming the capacitance of the oscillatory circuit and the inductor crucible forming the inductance or at least being a component of the inductance of the oscillatory circuit. An alternating inverter of the semiconductor generator is connected to this oscillatory circuit.

The maximum output power of the unit is about 320 kW according to an exemplary embodiment.

For the presently described dimensions of the inductor crucible, the power demand does not exceed a limit of 80 kW. For industrial production, it is also possible to provide geneators having higher output powers. In general, generators having output powers of up to 800 kW are adequate.

In the tests thus far, a generator voltage of at most 380 V was needed. This corresponds to an inductor voltage of about 650-700 V, because the generator voltage is increased by using the capacitor bank.

Another melting assembly, having an inductor crucible made of aluminum, is available. With the same diameter and a height of 240 mm, it has an effective volume capacity of about 11 liters. The construction was identical for the most part. This crucible was designed in order to exclude a further source of impurities by using aluminum. Aluminum oxide, which would be formed when the glass is impure, is a frequent constituent of glasses to be melted. Moreover, it causes no coloration whatsoever, in contrast to Cu, Fe, Cr, Ni, Pt, etc.

Skull crucibles and bottoms made of metal are constructed from rods having intervening slits, so that the high-frequency field is not completely absorbed already in the crucible.

Moreover, the cylindrical jacket and the bottom are electrically insulated from each other in order to suppress short circuits.

As a result of the slit design, the energy can be introduced through the rods into the melt and heat it. In the case of some skull crucibles and bottoms made of metal, however, the rods absorb a part of the energy (approximately 10-20%) and transform it to heat. The heat is dissipated via the cooling water and is lost for the process.

However, the slit construction always results in the danger that the glass runs out between the rods, in particular in the case of thin skull crusts and low-viscosity melts.

Through the use of a one-turn inductor crucible, the cylindrical radial wall now has a solid planar surface and melt can no longer run out. Also, no energy absorption whatsoever of the high-frequency field by additional metal rods (skull crucible) takes place any longer.

However, the bottom cannot be constructed as a metal disk.

The bottom has to be electrically insulated from the cylindrical surfaces in order to prevent short-circuit currents. In this case, however, it would act as an absorber and not allow any field to pass through, in particular when it is constructed as a planar surface.

A heating of the melt would no longer be possible.

A slit construction would offer no good leakage barrier and still lead to energy losses, albeit less than the above-given 10 to 20% for the whole construction.

If the bottom were to comprise the conventional ceramic refractory materials, a leakage barrier would initially exist and no loss due to absorption of electric energy would occur any longer. However, the partially quite aggressive melts would lead to the fact that the refractory material would be worn away gradually. The dissolved products would impair the glass quality.

However, even more detrimental would be the fact that the bottom would become increasingly thin and at some point break and this would lead to glass leakage with catastrophic consequences.

Such a design is therefore not feasible in practice.

An air or water cooling, as in the case for the metal rods, is not appropriate for the conventional refractory materials, because, in this case, the thermal conductivity is too low.

The very desirable combination of very low electrical conductivity (insulator) and good thermal conductivity cannot be achieved using the conventional metal or refractory construction materials of the glass industry.

However, the inventors have realized that, surprisingly, there are some ceramic materials, mostly based on non-oxides, which unite this usual combination of properties.

A particularly outstanding representative of this class of substances is aluminum nitride AlN, but the functional capability of the invention is not limited to this material, but rather there also exist other materials, such as, for example, titanium nitride, boron nitride, aluminum oxide, as well as Si₃N₄ having a thermal conductivity of approximately 50 W/m·K. Although these materials exhibit a lower thermal conductivity, the thermal conductivity of all of these materials is still greater than 20 W/m·K. This is generally adequate in order to achieve a sufficient cooling for creation of skull layer.

It is important that as little energy as possible is absorbed in the crucible bottom. For this reason, a material having a lower electrical conductivity is used.

The crucible bottom, just like the inductor, is preferably cooled with water in order to avoid that the ceramic is heated too strongly by the charging material and thereby, in turn, can corrode. For this reason, a material having higher thermal conductivity is used. This prevents, in a safe manner, the fluid glass from running out. However, an air cooling is also conceivable.

A particularly preferred embodiment comprises an aluminum nitride ceramic, hereinafter also referred to as the AlN ceramic for simplicity. In this case, the bottom is cooled such that its surface temperature at the side facing the melt, or at the crucible interior side, is less than 750° C., preferably less than 500° C.

In a preferred embodiment, the bottom comprises two parts, an upper bottom plate and a lower bottom plate.

The first part consists of the upper bottom plate furnished in general with the reference number 1, in which cooling water channels 2, 3, 4, and 5 are milled in accordance with FIG. 2 on the side facing away from the charging material.

Furthermore, the upper bottom plate 1 has millings into which the metal introduction lines for the cooling water are pressed.

Constructed at the edge on the side of the upper bottom place 1 facing the charging material is a crosspiece 15, which, in relation to its outer radius R1, defines a recessed inner region 6 having a radius R2.

Constructed on the side of the upper bottom plate 1 facing away from the charging material is another crosspiece 7, which, in relation to the outer radius R1, defines a recessed inner region 8 having the radius R2, inside of which an upper part of the lower bottom plate 9 can be accommodated.

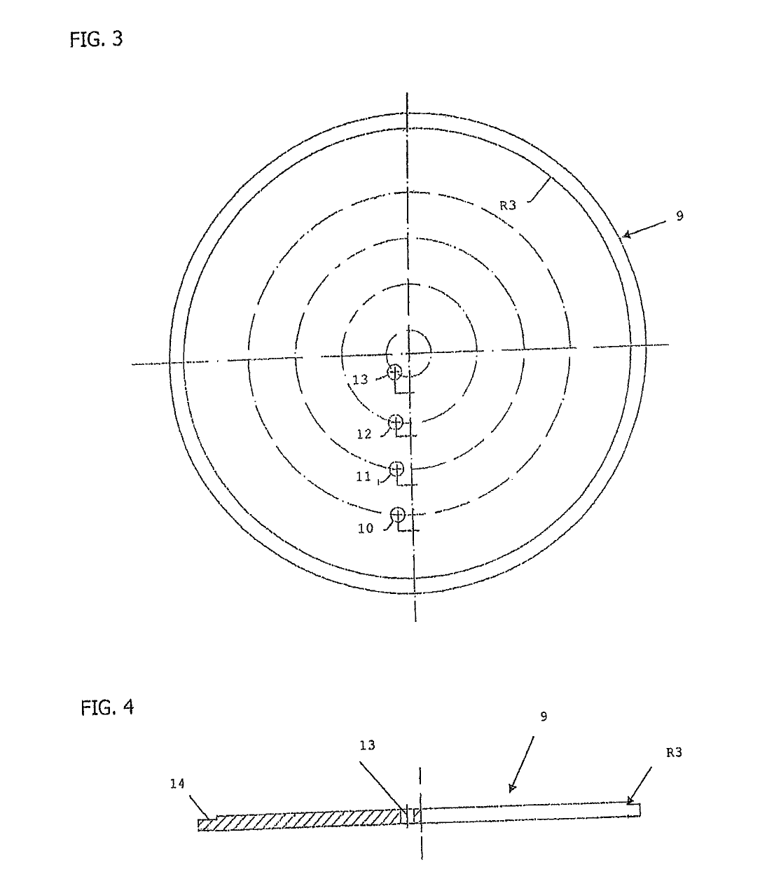

The lower bottom plate 9 according to FIGS. 3 and 4 is a relatively thin plate and serves to seal off the cooling water channels 2, 3, 4, and 5. Introduced in this part are the bores 10, 11, 12, and 13 for the cooling water connections.

The lower bottom plate 9 has a recess 14 running around the side edge and having an outer diameter of approximately R3, which is suitable for accommodating the crosspiece 7 of the upper bottom plate 1.

In a particularly simple embodiment, the lower bottom plate 9 is bonded adhesively to the upper bottom plate 1, in which the cooling channels are milled, by means of a commercially available two-component adhesive or an epoxy adhesive.

Conceivable, however, depending on need, are also other joining techniques, such as, for example, the fusion with a glass solder adapted to the thermal expansion.

Consequently, in the exemplary embodiment described, the AlN bottom consists of two disks, each of which has an outer diameter R1 of about 322 mm.

The two disks are bonded adhesively to each other such that the top side, with the milled cooling channels 2, 3, 4, and 5, is sealed off from the bottom side in a watertight manner.

The crosspiece 15 in the edge region of the upper bottom plate 1 forms a step that is approximately 10 mm high, which practically eliminates the danger of leakage of the melt.

The outer side of the inductor crucible adjoins the inner side of this step.

This crosspiece 15 or accordingly this step is interrupted at the point at which the introduction lines for the inductor crucible are located.

This recess has a width of 40 mm. Accommodated in this part of the bottom are four cooling channels that are 13 mm wide and 6 mm deep. The center position thereof is located at three radii, 15.5 mm, 46.5 mm, 77.5 mm, and 108.5 mm.

The two inner and the two outer channels are each joined to one another.

Located in the covering for this part are four bores, each 10 mm in diameter, in order to ensure the entry or exit for the cooling water. The thickness of this plate is about 10 mm. In order to ensure an adequate dissipation of the heat, the plate should not be too thick. On the other hand, it must have a minimum mechanical stability. In the exemplary embodiment described, it has therefore proven appropriate to use a thickness in the region of 8 to 12 mm. In other embodiments, however, other dimensions may be used.

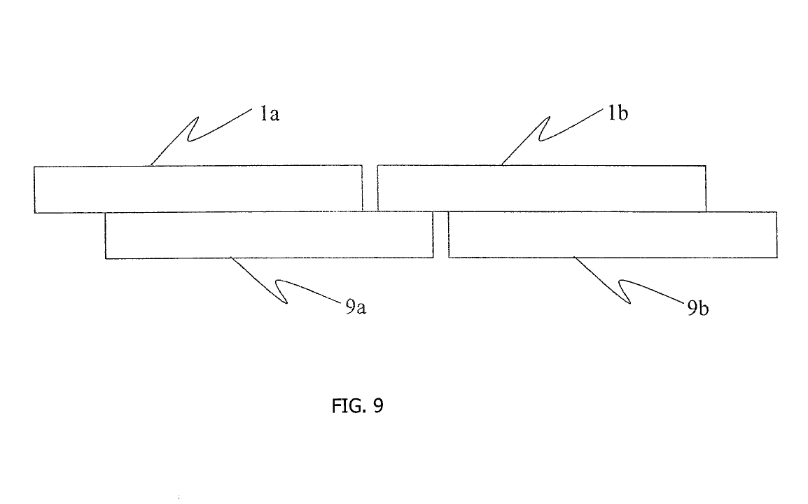

Insofar as the dimensions of the crucible do exceed certain values, there can arise the problem that one-piece bottoms of suitable size are not commercially available or are very costly. Therefore, in particular, in the case of large crucibles, the bottom can be composed of several components. In order to prevent these components from becoming displaced with respect to one another, the upper bottom elements 1a, 1b can be bonded, for example, to the lower bottom elements 9a, 9b (FIG. 9). Another possibility to prevent the individual components from “slipping” consists in providing the components with tongues and grooves, which can be joined to one another.

However, it should be advantageously ensured that a temperature of 800° C. at the hottest point is not exceeded, because, in the presence of oxygen (in air or pure oxygen), the oxidative decomposition of aluminum nitride commences starting at this temperature. However, under neutral to reducing conditions, which, for example, can be adjusted by using protective gases, higher temperatures are also possible.

However, it is to be heeded that the chemical interaction with the melt may result much earlier in damage to the material.

The maximum use temperatures of adhesive or glass solder should also not be exceeded. Although these lie always in the cooler regions of the arrangement, they are not thermally as loadable. At the sites in question, a temperature of preferably 200° C. and particularly preferably 180° C. should not be exceeded.

In practice, it has proven appropriate to adjust temperatures of 200° C. or less at the glass/upper bottom plate boundary. Under these conditions, no damage whatsoever to the material could be observed.

Various melting tests were carried out with the device according to the invention and using the method according to the invention. Used in a first exemplary embodiment was an extreme low-viscosity solder glass.

The composition and typical material properties are presented in Table 1 for Example 1. Due to the high concentrations of B₂O₃ and ZnO and due to the low viscosity of this material, a melting in conventional ceramic refractory materials, such as, for example, silica glass, would be fully ruled out, because these materials would dissolve in the melt completely in a very short time. Consequently, the unit would totally break down.

A melting in vessels made of noble metal might also not be possible, because the dissolving metal would interfere with or abolish the electrical properties of the product.

Although a melting process in a conventionally used skull crucible high-frequency unit would avoid the described drawbacks and afford a satisfactory glass quality, there would exist yet another drawback in the operation of the unit, besides the previously described technical drawbacks of the unit (two cooling circuits, flashovers, idle power losses at pipes and skull crucibles, complex and thus costly crucibles).

Because the glass is very low in viscosity and, due to the steep gradients of viscosity versus conductivity, overheating can readily occur, it could transpire that the glass melts through the skull crust and flows out between the pipes of the crucible.

If the spacings between the pipes are reduced in size, it might be possible to minimize the danger of leakage, but this would substantially reduce the in-coupling efficiency of the electromagnetic field, so that this approach would lead necessarily to an increase in operating costs.

It might be possible to prevent a glass melt breakthrough also by a complicated measurement and control system as well as by the use of highly qualified and well-trained personnel, but this would also lead to an appreciable increase in production costs.

Much more clever in this case is to use an inductor melting unit, the crucible of which, with its planar surface, prevents any leakage a priori in terms of its construction.

For the previously described exemplary embodiment with solder glass, 11 kg of material were poured in prior to the start of the test and preheated using a gas burner.

The burner was operated with constant recharging of glass at a propane/oxygen ratio of 1.2 to 12.

All voltage values given below relate to the voltage applied to the generator. Due to the voltage increase at the capacitor bank, the voltages applied to the inductor are greater by a factor of 1.7. After a time of about 30 min, the generator was switched on with a voltage of approximately 300 V at a frequency of 97.6 kHz and the power of the gas burner was reduced in steps.

At melting temperatures of about 1250° C., it was possible to reach a stationary state at which the glass in the crucible was completed melted. Required for this was a voltage of about 240 V and a total power of about 60 kW was taken from the mains supply. The total weight of the melt was about 18 kg.

In a second exemplary embodiment, a high-melting glass for fiber-optic applications with very good transmission was produced. The composition and properties are compiled in Table 1 for Example 2.

The melting temperatures for this glass lie at approximately 1400° C. At these temperatures, the conventional ceramic vessel materials are also strongly attacked by this glass.

A melt in noble metal vessels would also not come into consideration due to the yellow tinge introduced into the charging material and the strong increase in vaporization caused by these materials.

The corrosion-free melting method according to the invention affords the possibility of achieving high transmission values, because, in the ideal case, no impurities are introduced into the glass.

Quite good results have already been obtained here using the skull crucible units, although this glass has the tendency to form melt relicts in the form of ZnO or Zn₂SiO₄ inclusions when the supply of energy is insufficient.

Here, too, the inductor crucible method is advantageous due to the avoidance of the 10 to 20% idle power losses at the skull crucible and the higher currents and thus better local power transfers to the charging material.

In this second exemplary embodiment, 13.5 kg of the previously described glass was poured in prior to the start of the test and preheated using a gas burner. The burner was operated with constant recharging of glass, this time at a methane/oxygen ratio of 1.8 to 6. At the end of about 60 min, the generator was switched on with a voltage of approximately 250 V at a frequency of 97.3 kHz and the power of the gas burner was decreased in steps. Melting temperatures of about 1450° C. could be determined. In the stationary state, a voltage of about 350 V was required and the mains power lay at about 80 kW. The weight of the melt was 17.3 kg after the test.

TABLE 1
Glass composition of the glasses of the exemplary embodiments

| | Example 1 | Example 2 |
|---|---|---|
| | RFA (weight %) | (weight %) |
| Composition | | |
| components | | |
| SiO₂ | 9.7 | 48.64 |
| ZnO | 62.0 | 31.4 |
| B₂O₃ | 23.7 | — |
| Na₂O | — | 7.69 |
| K₂O | — | 6.06 |
| Li₂O | — | 0.87 |
| PbO | 3.1 | — |
| BaO | — | 0.83 |
| Bi₂O₃ | 0.11 | — |
| ZrO₂ | 0.01 | — |
| La₂O₃ | — | 4.3 |
| CeO₂ | 0.8 | ?— |
| Sb₂O₃ | 0.6 | — |
| As₂O₃ | — | 0.1 |
| Property | | |
| n_{d} | 1.67958 | 1.57997 |
| v_{d} | 45.68 | 51.78 |
| at 20-300 10⁻⁶ K⁻¹ | 4.45 | 9.1 |
| Tg ° C. | 546 | 508 |
| p g/cm³ | 3.83 | 3.13 |
| T(7.6): E_{w} ° C. | 632 | 657 |
| T(4): V_{A} ° C. | n.d. | 880 |
| T(2) ° C. | n.d. | 1162 |

The construction of a one-turn inductor crucible 20 will be explained below on the basis of the schematic view of FIG. 5. Already described was the inner coating 21, preferably with Al₂O₃, which is provided particularly in the region of the inductor gap 22. The crucible is constructed from several pipes 24, 26, 28, 30, which are joined to one another mechanically and, depending on the length, electrically and which form a crucible vessel 23 and continue in two arms 31, 32 running side by side with inclusion of the gap 22. The bottom of the crucible is closed off by the above-described upper and lower bottom plates 1, 9. An electrically insulating material, such as, for example, Teflon, can be provided between the arms in order to prevent electric flashovers there.

At the end of the arms 31, 32 is the electrical connection to the semiconductor generator. Each of the pipes 24, 26, 30 is furnished with its own cooling water connections 33, 34, 35, 36, which enable an individual supply of the pipes containing cooling fluid and, in particular, a control of the cooling power of the individual pipes. As a result, it is also possible to control the temperature profile in the melt to a certain extent. For example, it is possible in this way to promote the convection of the melt.

Provided at the crucible vessel 23 for a continuous melting or refining operation is a discharge outlet, through which the melted and/or refined melt is discharged. The outlet can be provided, for example, at the top edge of the crucible vessel. Suitable for the outlet, too, is a channel cooled in the manner of a skull crucible. The charging material is introduced onto the melt bath surface.

In order to prevent an outflow at the top edge of the crucible vessel such that introduced charging material would enter the discharge outlet directly, it is possible to provide a cooled barrier, which dips into the melt from above and blocks the direct path from the input region to the discharge outlet.

FIG. 6 shows an exemplary embodiment of an inductor crucible 20 constructed as a continuous melting assembly. The crucible vessel 23 preferably has a capacity of at least 15 liters, particularly preferably of at least 50 liters. In contrast to the exemplary embodiment shown in FIG. 5, the crucible vessel 23 has, moreover, a greater aspect ratio of the inner diameter to the depth. In the example illustrated, the inner diameter of the crucible is more than twice the depth. As a result, the glass melt 40 has a large free surface 41. This facilitates the melting of the charging material 42 input continuously or nearly continuously onto the surface 41. The input of the charging material 42 takes place in the device shown in FIG. 6 via a pipe 43 solely by way of example. For example, a conveyor belt may also be provided, which scatters the charging material 42 through the input opening 45 of the thermally insulating top cover 44 onto the surface 41 of the glass melt 40. Inserted through the bottom 19 with the bottom plates 1 and 9 is a ceramic or noble metal pipe 46 for discharging the melt. The melt is discharged through the pipe continuously.

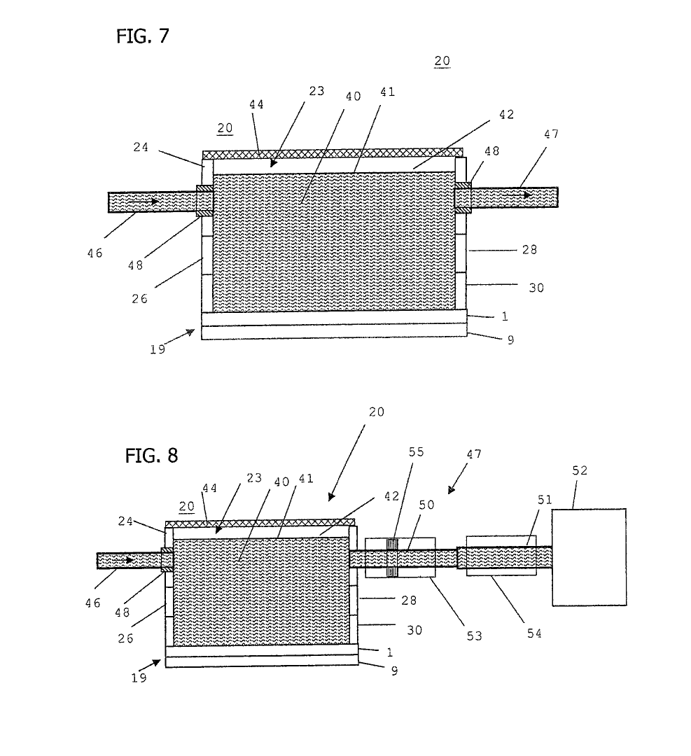

FIG. 7 shows an inductor crucible 20 constructed as a refining assembly. This device is also constructed, just like the device illustrated in FIG. 6, for the continuous processing of glass melts 40. This device, too, has an insulating cover 44 for thermal insulation.

Provided for the glass melt 40 is an outflow 46 and in inflow 47, both of which open up through the electrically conducting side wall of the inductor crucible 20 into the crucible vessel 23. Both the inflow 46 and the outflow are constructed as pipes. Alternatively conceivable are also channels. For both pipes and channels, just as for the outflow shown in FIG. 6, it is possible to employ noble metal as a material. In this case, it may be advantageous to insulate the pipes electrically from the crucible side wall by means of insulation element 48 in order to prevent an in-coupling of the high-frequency currents into the pipes. Also offered as a possibility for the insulation elements 48 as well as for the plates 1, 9 of the bottom 19 is the use of an electrically insulating, but thermally conductive ceramic. In this refining assembly, both the inflow and the outflow of the melt 40 takes place preferably continuously. In contrast to what is illustrated in FIG. 7, also conceivable is a configuration in which the inflow 46 or the outflow 47 runs through the inductor gap. Also conceivable is such a configuration for an outflow in a melting assembly.

FIG. 8 shows a variant of the exemplary embodiment shown in FIG. 7. Here, the outflow 47 is constructed as a conditioning segment. The conditioning segment is composed of two elements 50, 51 conducting the melt and connects the inductor crucible 20 to another device 52. The device 52 can be, for example, a glass-shaping device, such as, for instance, a roller device for the production of panes of glass. The first melt-conducting element 50 of the conditioning segment is fabricated, just like the bottom 19, of an aluminum nitride-containing ceramic. Here, too, a boron nitride-containing aluminum nitride ceramic also represents a particularly suitable material.

Adjoining the first melt-conducting element 50 is another melt-conducting element 51 made of noble metal, preferably platinum or a platinum alloy. The melt is cooled down in a controlled manner along the flow direction. Provided for this purpose are cooling fluid jackets 53, 54, preferably for cooling liquid, but alternatively or additionally also for gas as the cooling fluid, which surround the melt-conducting elements 50, 51 designed as pipes. In this case, during flow through the ceramic element 50, the melt 40 is cooled down to a temperature that is compatible with the noble metal material of the other melt-conducting element 51. Optionally, it is also possible to provide heating devices in order to be able to control in a targeted manner the conditioning of the melt. Offered as a possibility here for the region of the first ceramic melt-conducting element is, once again, an induction coil 55. A heating in the region of the other melt-conducting element 52 can take place, for example, directly in a conductive manner by passing an electric current through the electrically conducting noble metal pipe.

In place of pipe-shaped melt-conducting elements 50, 51, it is also possible to employ channel-shaped elements. Pipes are advantageous in order to achieve a uniform cooling. In addition, it is possible to prevent any contact with air when they are filled completely with melt. In the case of channels, by contrast, a very fast cooling can take place as well as also a simple heating by means of a burner above the melt.

It is obvious to the skilled practitioner that the invention is not limited to the exemplary embodiments described above, but rather can be varied in many different ways. In particular, the individual features of the exemplary embodiments can also be combined with one another.

What is claimed is:

1. A method for the continuous production of products from a melt, comprising:
feeding melt raw materials or a pre-melt materials into a skull crucible;
heating the melt raw materials or the pre-melt materials to a predetermined temperature in a skull crucible with a high-frequency alternating field to form the melt, wherein the skull crucible has a side wall comprising a coil for application of the high-frequency alternating field;
discharging, continuously, the melt heated to the predetermined temperature; and
cooling the side wall and a bottom of the skull crucible so that a skull layer is formed in the melt in an interior of the skull crucible,
wherein the side wall comprises an electrically conductive inductor and the bottom comprises an electrically non-conductive, but thermally conductive material,
wherein the bottom has an electrical conductivity of less than 10⁻³ S/m at a temperature of 20° C. and a thermal conductivity of at least 20 W/m·Km, and
wherein the bottom comprises a nitride ceramic that has an oxygen content of less than 2 mol %.

2. The method according to claim 1, wherein the side wall forms a one-turn inductor that generates the high-frequency alternating field.

3. The method according to claim 2, further comprising operating the one-turn inductor with an alternating current with a frequency alternating in the range of 70 kHz to 2 MHz.

4. The method according to claim 2, further comprising operating the one-turn inductor with an alternating current with a frequency of at most 90 kHz.

5. The method according to claim 1, wherein heating the melt raw materials or pre-melt materials with the high-frequency alternating field comprises inputting electrical power to the coil, at least 40% of the electric power being introduced into the melt as thermal energy.

6. The method according to claim 1, wherein the skull crucible is operated with a voltage of up to 750 V.

7. The method according to claim 1, wherein the melt has a temperature interval of at most 500° C. lying between a viscosity of 10^{7.6} dPa·s and 10³ dPa·s.

8. The method according to claim 1, wherein the melt is a borate-containing glass comprising at least one metal oxide, metal ions of which are divalent or at higher valency, with a molar proportion of at least 25 mol % and a ratio of the molar proportion of silicon dioxide to borate in the charging material is less than or equal to 0.5.

9. The method according to claim 1, wherein the discharging step comprises discharging, continuously, the melt through a ceramic or noble metal pipe that is joined to the bottom of the skull crucible.

10. The method according to claim 1, wherein the discharging step comprises discharging, continuously, the melt through the side wall of the skull crucible.

11. A device for the continuous production of products from a melt, comprising:
a feeding device configured to feed melt raw materials or pre-melt materials;
a skull crucible configured to heat the melt raw materials or the pre-melt materials to a predetermined temperature to form the melt, the skull crucible having a side wall comprising an electrically conductive inductor and a bottom comprising a material having, at a temperature of 20° C., a thermal conductivity of at least 20 W/m·K and an electrical conductivity of less than 10⁻³ S/m, wherein the bottom comprises nitride ceramic having an oxygen content of less than 2 mol %;
a cooling device configured to cool the side wall and the bottom; and
a pipe configured to continuously discharge the melt heated to the predetermined temperature.

12. The device according to claim 11, wherein the skull crucible is a one-turn inductor crucible.

13. The device according to claim 12, wherein the electrically conductive inductor operates with an alternating current having a frequency in a range of 70 kHz to 1400 kHz.

14. The device according to claim 11, wherein the nitride ceramic is selected from the group consisting of aluminum nitride, an aluminum nitride-containing ceramic, titanium nitride, and boron nitride.

15. The device according to claim 11, wherein the bottom comprises a plurality of components made of nitride ceramic.

16. The device according to claim 15, wherein the plurality of components are joined by mutually engaging elements.

17. The device according to claim 11, wherein the material has a dielectric constant of less than 8 at a frequency of 1 MHz.

18. The device according to claim 11, wherein the thermal conductivity is greater than 85 W/m·K at a temperature of 20° C.

19. The device according to claim 11, further comprising an insulation coating an interior-side of the skull crucible.

20. The device according to claim 19, wherein the insulation coating comprises an aluminum oxide coating.

21. The device according to claim 19, further comprising an electrically insulating coating in a region of an inductor gap.

22. The device according to claim 11, wherein the device has an efficiency for which at least 40% of input electric power is introduced as thermal energy into the melt.

23. The device according to claim 11, wherein the skull crucible is configured for melting temperatures greater than 3000° C.

24. The device according to claim 11, wherein the skull crucible has a capacity of at least 15 liters.

25. The device according to claim 11, wherein the skull crucible has an inner diameter that is at least one and a half times a depth of the skull crucible.

26. The device according to claim 11, further comprising a conditioning device attached to the skull crucible, the conditioning device having a first melt-conducting element and a second melt-conducting element connected thereto, wherein the first melt-conducting element is a ceramic pipe or a ceramic channel, the ceramic of which contains a nitride ceramic, and wherein the second melt-conducting element is a noble metal pipe or a noble metal channel.

27. A skull crucible, comprising:
a device for infeed and outfeed of melts, the device comprising a connecting element made of a material having, at a temperature of 20° C., a thermal conductivity greater than 20 W/m·K and an electrical conductance less than 10⁻³ S/M.

28. The skull crucible according to claim 27, wherein the connecting element comprises ceramic material.

29. The skull crucible according to claim 27, wherein the connecting element comprises aluminum nitride-containing ceramic material.

30. The skull crucible according to claim 27, wherein the connecting element is cooled.

31. The skull crucible according to claim 30, wherein the connecting element surrounds, at least in partial regions, a pipe or a channel made of ceramic or noble metal.

32. The skull crucible according to claim 31, wherein the pipe or the channel projects into the melt and wherein the connecting element cools the pipe or the channel projecting into the melt.

33. The skull crucible according to claim 27, wherein the connecting element passes through a bottom or a side wall of the skull crucible.
